(19) United States
(12) Patent Application Publication
(10) Pub. No.: US 2026/0195272 A1
(43) Pub. Date: Jul. 9, 2026

(54) Execution of a command generated by a user on a device

(71) Applicant: ORANGE, ISSY-LES-MOULINEAUX (FR)

(72) Inventors: Jean François Letellier, Chatillon (FR); Cédric Floury, Chatillon (FR)

(21) Appl. No.: 18/997,928

(22) PCT Filed: Jul. 18, 2023
(86) PCT No.: PCT/EP2023/069931

§ 371 Date: Jan. 23, 2025

(30) Foreign Application Priority Data
Jul. 25, 2022 (FR) FR2207606

(51) Int. Cl. G06F 13/10; G06F 40/30; G06V 30/18

(52) U.S. Cl. CPC G06F 13/10; G06F 40/30; G06V 30/18

(57) ABSTRACT

A method for executing a command generated via at least one input peripheral of an electronic device within the framework of an active application. The method is implemented by another application running in the background and includes: obtaining a string of at least one character displayed on a display peripheral of the electronic device in the graphical environment of an active application and generated by at least one data coming from the input peripheral; determining, at least as a function of the string of characters and of a context of the active application, whether the string of characters constitutes a command from a user of the electronic device; and when the determination is positive: deleting the string of characters on the display peripheral; and executing the command.

### 1. FIELD OF THE INVENTION

The invention relates to the field of computer applications and more particularly concerns a command execution service provided, for example, by a personal computer.

### 2. PRIOR ART

Computer terminals (personal computers, tablets, smart phones, etc.) offer numerous applications to users (messaging applications, word processing, spreadsheets, search engines, calculators, etc.).

In the current state of the art, each of these applications runs in its own environment, typically in a window, and the information entered in these environments is interpreted and processed within the context of these applications.

For example, information entered by a user when he uses a word processing is only interpreted within the context of this word processing.

The invention offers a solution that overcomes these limitations.

### 3. DISCLOSURE OF THE INVENTION

The invention improves the state of the art and proposes for this purpose a method for executing a command generated via at least one input peripheral of an electronic device within the framework of an active application, the method implemented by another application running in the background.

According to the invention, the method comprises:
obtaining a string of at least one character displayed on a display peripheral of said electronic device in the graphical environment of an active application and generated by at least one data coming from said at least one input peripheral;
determining whether said string of characters constitutes a command from a user of said electronic device, said determination being a function of said string of characters;
   and when the determination is positive:
deleting said string of characters on said display peripheral; and
executing said command.

Particularly, in some embodiments, the method comprises:
obtaining a string of at least one character displayed on a display peripheral of said electronic device in the graphical environment of an active application and generated by at least one data coming from said at least one input peripheral;
determining whether said string of characters constitutes a command from a user of said electronic device, said determination being a function of said string of characters and furthermore a function:
   of the active application; and/or
   of a date of obtaining the string of characters; and/or
   a place of obtaining the string of characters;
      and when the determination is positive:
deleting said string of characters on said display peripheral; and
executing said command.

According to at least one embodiment, the method comprises:
a step of obtaining a string of at least one character displayed on a display peripheral of said electronic device in the graphical environment of an active application and generated by at least one data coming from said at least one input peripheral;
a step of determining, at least as a function of said string of characters and of a context of said active application, whether said string of characters constitutes a command from a user of said electronic device; and when the determination is positive;
a step of deleting said string of characters on said display peripheral of said electronic device; and
a step of executing said command.

Advantageously, the execution method makes it possible to obtain the strings of characters generated by the user in an active application, to detect whether this string of characters constitutes a command, outside the framework of the active application, and if so to execute it and to delete the text corresponding to the command on the display peripheral.

Thus, thanks to the invention, a user can type a command that cannot be interpreted within the framework of the active application, without leaving the active application, this command being detected by another application in the background and executed. For example, a command intended to control a home automation appliance, such as turning on a lamp, can be detected in a word processing application and executed, the text corresponding to the command also being deleted from a text currently edited in the word processing application.

It is meant by graphical environment of a software application any display zone assigned to this application on a display peripheral (such as a screen) coupled to an electronic device on which this application is at least partially running. In particular, a window of a windowing system, a pop-up bubble, a spreadsheet and an information zone constitute examples of a graphical application environment within the meaning of the invention.

It is customary to designate by “active window”, the graphical environment of the active application.

It is meant by input peripheral any device able to interpret a user action in the form of commands, functions or instructions allowing the printing, storage or emission of characters (alphanumeric, punctuation, etc.). The input peripheral is for example a keyboard, a screen and/or a touch surface, a mouse, a microphone (via speech recognition software), etc. For simplification, it may be subsequently said that a string of characters is entered, regardless of the input peripheral or of the method used for its generation.

It is meant by display peripheral any device able to graphically render multimedia content (text, graphical interface, image, video, animation, clickable links, buttons, thumbnails, etc.), for example a screen or a projector.

It is meant by electronic device any device able to at least manage a display peripheral and/or an input peripheral (personal computer, Smartphone, electronic tablet, television, on-board computer of a car, connected objects, etc.).

According to at least one embodiment, a method as described above comprises a continuous storage of the characters entered by a user in a buffer zone of a memory reserved for the active application.

According to at least one embodiment, said determination takes into account a type of an input zone for said string of characters.

According to at least one embodiment, a method as described above is characterized in that it includes:
a step of determining a position of the display of said string of characters on said display peripheral; and
a step of displaying, on said display peripheral and in the vicinity of said position, a result of the step of executing said command.

In other words, in at least this embodiment, the text of the user-generated command is replaced by the result of execution of the command.

For example, if a user enters the string of characters (“convert 32 degrees Fahrenheit into degrees Celsius”) in a text editor, this string of characters is automatically detected in the background, interpreted as a temperature conversion command, and the result of the conversion “0° C.” is substituted for the string of characters.

For example, if a user enters the string of characters (“insert the last image received by email”) in a graphical presentation software, this string of characters is automatically detected by the application in the background, interpreted as a command, and the string of characters is automatically replaced by the last image received by the user's messaging application.

For example, in at least one embodiment, where the messaging application provides an Application Programming Interface (API), the latter can be queried by the method to obtain the last image received by email. As a variant, the messaging application can record in a memory known to the method any image received by email, as well as the date of receipt of this image.

The position of the string of characters where the result must be inserted can be determined by storing for example the coordinates of a mouse or of a cursor at each new insertion of a string of characters in the active application.

As a variant, this position can be determined within an image representative of the graphical interface of the electronic device.

Thus, when a correspondence is found between the last word(s) entered in the active window by the user (and representative of a command) and text elements generated by the optical character recognition, the method can determine the position of the last word(s) entered within the image by recovering for example the position of the last character of this set of words. Once the position/location of the position is determined, the method can display the result of the execution of the command at this position.

The location may for example correspond to coordinates (in pixels, in centimeters, etc.) interpretable by the display peripheral of the electronic device.

Thus, according to at least one embodiment, a method as described above is characterized in that it includes a step of searching and, when the search is positive, of detecting said string of characters in at least a second string of characters obtained by an optical character recognition step applied to all or part of an image representative of a content displayed by said display peripheral.

According to at least one embodiment of the invention, a method as described above is characterized in that said optical character recognition is applied to part of said image whose coordinates correspond to those of the graphical environment of the active application (for example to the active window) displayed by said display device.

This embodiment makes it possible to limit the execution of the optical character recognition to a zone/part of the image representative of the content displayed by the display peripheral of the electronic device corresponding to the graphical environment of the active application. This embodiment makes it possible to optimize the use of the resources (memory, processor, etc.) necessary for the execution of the method.

According to at least one embodiment, a method as described above is characterized in that it is executed as soon as at least one special character is detected. For example, before any command, it may be agreed that the user enters the command with a fixed string of characters(s), that can be parameterized for example as “##”.

As a variant, according to at least one embodiment, a method as described above is characterized in that it is executed as soon as the user finishes a word (detection of a space or of a punctuation mark) or pauses during the entry (for at least a first duration that can be parameterized for example of the order of a few seconds, or even a few tens of seconds (such as 2, 3, 5, 10, 15 or 20 seconds).

As a variant, according to at least one embodiment, a method as described above is characterized in that it is executed at regular intervals (for example of a duration of the order of a few seconds, or even a few tens of seconds (such as 2, 3, 5, 10, 15 or 20 seconds). This duration can for example be parameterized.

Such an embodiment makes it possible to adjust the processing time of the commands by varying the duration of this interval.

According to at least one embodiment, said determination step includes a semantic analysis of said string of characters and said execution step includes a processing of the result of said semantic analysis by at least one agent.

This implementation makes it possible to install different agents to process different types of commands (numerical calculation, home automation, accounting, business application, etc.).

The agents can be implemented for example in the form of a “plug-in”, and/or additional modules. Depending on the embodiments, an agent can be dedicated to one or more application(s).

In at least one embodiment, the execution method includes a pre-activation step via an input interface of said device.

In at least one embodiment, the execution method is executed:
upon detection of at least a first character (such as a predetermined character); and/or
upon detection of the end of a word; and/or
upon detection of a pause in the generation of said characters.

The invention also relates to a device for executing a command generated via at least one input peripheral of an electronic device within the framework of an active application.

The device can be configured to implement the method of the present application in any one of its embodiments.

Thus, according to at least one embodiment, the device comprises:
a module for obtaining a string of at least one character displayed on a display peripheral of said electronic device in the graphical environment of an active application and generated by at least one data coming from said at least one input peripheral;
a determination module configured to determine whether said string of characters constitutes a command from a user of said electronic device, said determination being a function of said string of characters;
a module for deleting said string of characters on said display peripheral of said electronic device; and
a module for executing said command.

More specifically, according to at least one embodiment, the device comprises:
a module for obtaining a string of at least one character displayed on a display peripheral of said electronic device in the graphical environment of an active application and generated by at least one data coming from said at least one input peripheral;
a determination module configured to determine, at least as a function of said string of characters and of a context of said active application, whether said string of characters constitutes a command from a user of said electronic device;
a module for deleting said string of characters on said display peripheral of said electronic device; and
a module for executing said command.

According to at least one embodiment, the device comprises:
a module for obtaining a string of at least one character displayed on a display peripheral of said electronic device in the graphical environment of an active application and generated by at least one data coming from said at least one input peripheral;
a determination module configured to determine whether said string of characters constitutes a command from a user of said electronic device, said determination being a function of said string of characters and furthermore a function:
   of the active application; and/or
   of a date of obtaining said string of characters; and/or
   of a place of obtaining said string of characters;
a module for deleting said string of characters on said display peripheral of said electronic device; and
a module for executing said command.

The term module can correspond to both a software component and a hardware component or a set of hardware and software components, a software component itself corresponding to one or more computer program(s) or subprogram(s) or more generally to any element of a program able to implement a function or a set of functions as described for the modules concerned. In the same way, a hardware component corresponds to any element of a set of hardware able to implement a function or a set of functions for the module concerned (integrated circuit, smart card, memory card, etc.).

The invention also relates to a computer program including instructions for the implementation of the method above according to any one of the particular embodiments described above, when said program is executed by a processor. The method can be implemented in various ways, in particular in wired form or in software form. This program can use any programming language, and be in the form of source code, object code, or intermediate code between source code and object code, such as in a partially compiled form, or in any other desirable form.

The invention also relates to a system for executing a command generated via at least one input peripheral of an electronic device within the framework of an active application.

The system can be configured to implement the method of the present application in any one of its embodiments.

Thus, according to at least one embodiment, the system comprises:
a device for obtaining a string of at least one character displayed on a display peripheral of said electronic device in the graphical environment of an active application and generated by at least one data coming from said at least one input peripheral;
a determination device configured to determine whether said string of characters constitutes a command from a user of said electronic device, said determination being a function of said string of characters;
a device for deleting said string of characters on said display peripheral of said electronic device; and
a device for executing said command.

More specifically, according to at least one embodiment, the system is characterized in that it comprises:
a device for obtaining a string of at least one character displayed on a display peripheral of said electronic device in the graphical environment of an active application and generated by at least one data coming from said at least one input peripheral;
a determination device configured to determine, at least as a function of said string of characters and of a context of said active application, whether said string of characters constitutes a command from a user of said electronic device;
a device for deleting said string of characters on said display peripheral of said electronic device; and
a device for executing said command.

According to at least one embodiment, the system comprises:
a device for obtaining a string of at least one character displayed on a display peripheral of said electronic device in the graphical environment of an active application and generated by at least one data coming from said at least one input peripheral;
a determination device configured to determine whether said string of characters constitutes a command from a user of said electronic device, said determination being a function of said string of characters and furthermore a function:
   of the active application; and/or
   of a date of obtaining said string of characters; and/or
   of a place of obtaining said string of characters;
a device for deleting said string of characters on said display peripheral of said electronic device; and
a device for executing said command.

The invention also relates to a recording medium or information medium readable by a computer, and including instructions of a computer program as mentioned above. The recording media mentioned above can be any entity or device capable of storing the program. For example, the medium can include a storage means, such as a ROM, for example a CD ROM or a microelectronic circuit ROM, or a magnetic recording means, for example a hard disk. On the other hand, the recording media can correspond to a transmissible medium such as an electrical or optical signal, which can be conveyed via an electrical or optical cable, by radio or by other means. The programs according to the invention can particularly be downloaded on an Internet-type network.

Alternatively, the recording media can correspond to an integrated circuit in which the program is incorporated, the circuit being adapted to execute or to be used in the execution of the method in question.

This execution device, this execution system and this computer program have characteristics and advantages similar to those described above in relation to the execution method in all its embodiments.

The different embodiments of the execution method, of the execution device or of the execution system mentioned above or described below can be combined.

### 4. LIST OF THE FIGURES

Other characteristics and advantages of the invention will become more clearly apparent upon reading the following description of particular embodiments, given as simple illustrative and non-limiting examples, and the appended drawings, among which:

FIG. 1 illustrates exemplary environment of implementation of the invention according to one particular embodiment of the invention,

FIG. 2A illustrates the architecture of a device adapted for the implementation of the execution method, according to one particular embodiment of the invention,

FIG. 2B illustrates the architecture of a device adapted for the implementation of the execution method, according to another particular embodiment of the invention,

FIG. 3 illustrates one exemplary implementation of the invention;

FIG. 4 illustrates one exemplary implementation of the invention;

FIG. 5 illustrates the main steps of the execution method according to one particular embodiment of the invention.

### 5. DESCRIPTION OF ONE EMBODIMENT OF THE INVENTION

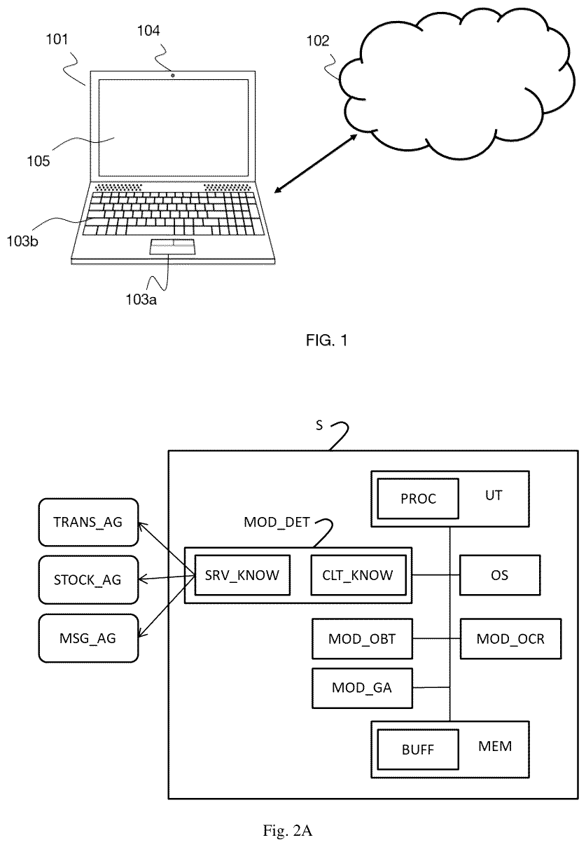

FIG. 1 illustrates one exemplary environment of implementation of the invention according to at least one embodiment. The environment represented in FIG. 1 comprises at least one electronic device 101 that integrates a device for executing a command able to implement the method for executing a command according to the present invention.

According to other embodiments, the execution device may be located in the network and/or distributed over one or more computer machine(s) such as computers, terminals or servers. The electronic device 101 is for example a terminal of the Smartphone type, tablet, connected television, connected object, on-board computer of a car, personal computer or any other terminal able to render multimedia content visually and/or vocally. One or more graphic/display or sound 105 rendering peripheral(s) may be connected or included by the electronic device 101 (connected in a wired (via a VGA, HDMI, USB cable, etc.) or wireless (WiFi®, Bluetooth®, etc.) manner. This or these rendering peripherals can for example be a screen, a video projector, a speaker, etc.).

According to one embodiment of the invention, the graphical or sound rendering peripheral(s) can be connected to the electronic device 101 via the network 102.

Likewise, one or more input peripheral(s) 103a, 103b can be connected or included by the electronic device 101 (connected in a wired (via a VGA, HDMI, USB cable, etc.) or wireless (WiFi®, Bluetooth®, etc.) manner. This or these input peripherals can for example be a keyboard, a mouse, a touch surface, a camera 104, a microphone or any other peripheral able to provide interaction data coming from the user of the electronic device 101.

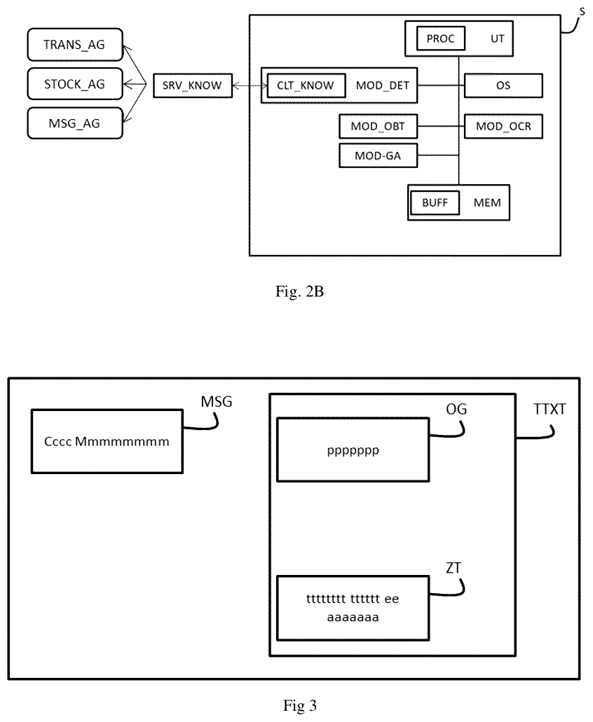

FIGS. 2A and 2B each illustrate a device S configured to implement the acquisition method according to at least one embodiment of the invention. The device S has the conventional architecture of a computer, and comprises in particular an operating system OS, a memory MEM, a processing unit UT, equipped for example with a processor PROC, and driven by the computer program PG stored in memory MEM, an obtaining module MOD_OBT, an action management module MOD_GA and a determination module MOD_DET. The computer program PG comprises instructions for implementing the steps of the execution method as described later in support of FIG. 5, when the program is executed by the processor PROC.

On initialization, the code instructions of the computer program PG are for example loaded into a memory before being executed by the processor PROC. The processor PROC of the processing unit UT in particular implements the steps of the execution method according to any one of the embodiments described in relation to the present application (for example in relation to FIG. 5) and according to the instructions of the computer program PG.

In at least one embodiment, the determination module MOD_DET is configured to interface with a plurality of agents, only three of which are represented in FIGS. 2A and 2B.

In at least one embodiment represented in FIG. 2A, the determination module MOD_DET includes a client CLT_KNOW and a knowledge server SRV_KNOW comprised in the device S. At least some agents may also be comprised in the device S.

In at least one embodiment represented in FIG. 2B, the client CLT_KNOW and the knowledge server SRV_KNOW are connected via a communication network.

The obtaining module MOD_OBT is configured to obtain at least one string of characters from data generated by at least one user (sound, movement, click, press (long or short), etc.) at an input peripheral (103a (touchpad), 103b (keyboard)) of the electronic device 101. These data are interpreted and translated into characters. This is for example the case when pressing the keys of the keyboard 103b of the electronic device 101, during an action (movement, click) performed on a touch surface 103a, during a textual transcription of a speech in sign language captured by the camera 104 of the electronic device 101 or during a textual transcription of an audio speech captured by a microphone (not represented) of the electronic device 101.

In at least some embodiments of the method, the obtaining module MOD_OBT can subscribe to the operating system OS in order to be notified of at least some system events. For example, the obtaining module MOD_OBT receives from the operating system OS:
an identifier of the active application during a (for example at each) change of the active application; and
an event representative of at least some user actions to generate input data (mouse click, key input on the keyboard, etc.).

In at least some embodiments of the method, the memory MEM includes at least one buffer zone BUFF (for example a single buffer zone) that stores the characters generated by the user inputs continuously in a window of an active application, these characters being obtained by the obtaining module MOD_OBT by notification of the operating system OS. For example, in the example illustrated in FIG. 3, assuming that a user:
i/ enters the string of characters “Dear” (illustrated by the string of characters “Cccc” in FIG. 3) in a messaging application MSG with identifier ID_MSG; then
ii/ switches to another application, for example a word processing TTXT with identifier ID_TTXT to enter the string of characters “fish” (illustrated by the string of characters “ppppppp” in FIG. 3) in a graphical object OG, then the string of characters “translate trout into English” (illustrated by the string of characters “Tttttttt tttttt ee aaaaaaa” in FIG. 3) in a text zone ZT; then
iii/ switches back to the messaging application MSG to continue his message by entering the string of characters “Mister” (illustrated by the string of characters “Mmmmmmmm” in FIG. 3), the buffer zone BUFF includes the string of characters “Dearfishtranslate trout into English Sir”.

In another embodiment of the method, the memory MEM includes a buffer zone per application and/or per application window to continuously store the characters entered by the user in a window of an application when this application is active.

Thus, by reconsidering the example of FIG. 3, the memory MEM may include:
a first buffer zone BUFFMSG including the string of characters “Dear Sir” corresponding to the characters entered in two stages by the user when the messaging application MSG is active; and
a second buffer zone BUFFTTXT including the string of characters “fishtranslate trout into English” corresponding to the characters entered by the user when the word processing TTXT is the active application.

In the embodiment described here, as soon as the end of a word in a string of characters is detected, for example by detecting a space, a punctuation mark, or a pause greater than a first duration in the user's input, the method determines a context of the active application in which this string of characters was entered. The determined context can for example allow the method to determine (i) whether this word constitutes a command and (ii) the actions to be implemented in order to execute this command.

Indeed, the same string of characters can be interpreted or not as a command depending on the active application in which this string of characters was generated. For example, the word “holidays” can be interpreted as a command to access a website relating to holidays in a profile (history for example) of the user, only when this word holidays is entered in the URL of a Web page.

Moreover, the same command can be processed differently depending on a context of the active application. For example:
based on a graphical object or on a word detected in the vicinity of the string of characters; and/or
based on a place and/or on a date of use of the electronic device 101 at the time of generating the string of characters.

In at least some detailed embodiments, the device S may comprise an optical character recognition module MOD_OCR able to perform optical character recognition on an image (image capture) representative of a content displayed by a display peripheral (105) of the electronic device 101 and to obtain at least a second string of characters TXT2 as a result of the optical character recognition.

It should be noted that the image is for example generated via software able to perform a capture of the graphical content of a screen 105 of the electronic device 101.

Thus, by reconsidering the example above in FIG. 3, three strings of characters TXT2¹, TXT2² and TXT2³ may be obtained by optical character recognition applied to the image representative of the content displayed on the screen 105:
TXT2¹: “Dear Sir”; and
TXT2²: “fish”; and
TXT2³: “translate trout into English”.

In at least some detailed embodiments, the device S may also comprise a search module MOD_SEARCH able to search and detect within a string of characters TXT2 obtained thanks to the optical character recognition, a string of characters (for example one or more word(s)) obtained via the obtaining module MOD_OBT. This search can be carried out, as soon as the module MOD_OBT detects the end of a word in a string of characters for example.

The optical character recognition may be optional in at least some embodiments but it can help to distinguish, as illustrated in the example of the word processing TTXT, several strings of characters (“fish”, “translate trout into English”) entered by the user in different input zones of the same application.

In at least some detailed embodiments, the optical character recognition module MOD_OCR is configured to determine that a string of characters is located in the vicinity of a graphical object, for example a graphical object or a particular text.

For example, in the case of the image of FIG. 3, the optical character recognition module MOD_OCR can determine that the string of characters “fish” is located in a rectangle.

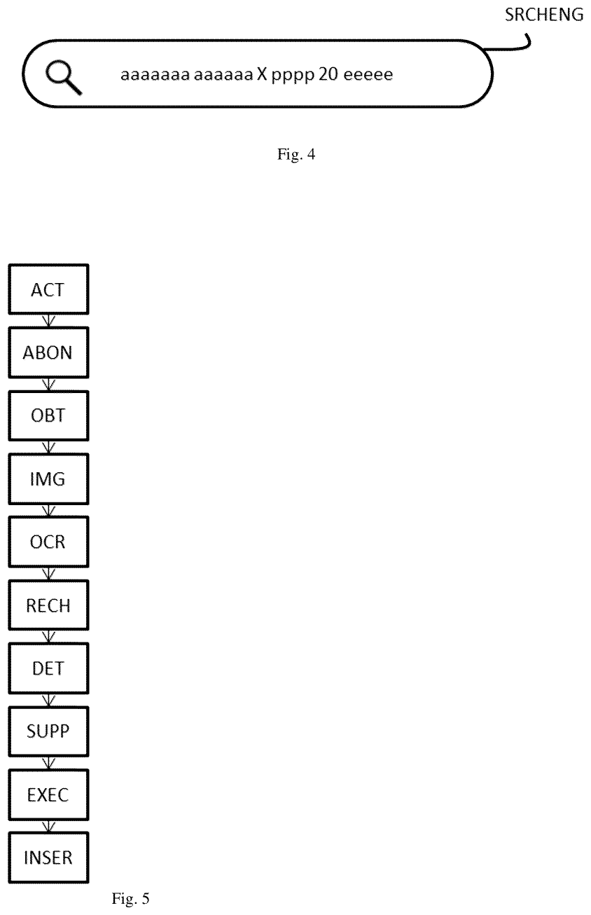

For example, in the case of the image of FIG. 4, the optical character recognition module MOD_OCR can determine that the string of characters “buy stock X for 20 Euros” (illustrated by the string of characters “aaaaaaa aaaaaa X pppp 20 eeeee” in FIG. 4) is located in an oblong shape, in the vicinity of a magnifying glass of a search engine application SRCHENG with identifier ID_SRCHENG.

In at least one embodiment, an input zone type can be determined, for example by implementing a pre-learning mechanism based on annotated graphical interface images.

Particularly, some embodiments may use methods for determining URL input zones, for example methods operating based on the recognition of the (elongated) shape and position (generally at the top) of such input zones within the graphical environment of the applications presenting such zones.

In at least some embodiments, the optical character recognition module MOD_OCR is configured to determine the position POS of a string of characters in the image representative of the content displayed on the screen 105.

In at least some embodiments, the device S may include a determination module MOD_DET configured to determine at least as a function of the string of characters obtained by the obtaining module MOD_OBT and of a context of an application of the active electronic device 101 at the time of obtaining said string of characters, whether this string of characters constitutes a command from the user of the electronic device 101.

In at least some embodiments, the determination module MOD_DET may include a client CLT_KNOW, cooperating for example with a knowledge server SRV_KNOW (implemented for example in the form of a web service, a library or a database).

The context of the active application may in particular include:
the identifier ID_APP of the active application;
a type of the input zone in which the string of characters is detected;
information relating to one or more graphical and/or textual object(s) detected by the module MOD_OCR and located in the vicinity of the string of characters;
a date and/or a place of use of the electronic device 101 at the time of obtaining the string of characters.

The client CLT_KNOW and the knowledge server SRV_KNOW can communicate according to at least one protocol. This protocol for example makes it possible to characterize a string of characters, an active application identifier, a type of input zone, a date or a place of use of the electronic device, a graphical object including the string of characters or located in the vicinity of the string of characters, and/or a text located in the vicinity of the string of characters. Thus, a protocol cited as a simple illustrative example could comprise:
the keyword “TXT” to introduce a string of characters;
the keyword “ID_APP” to introduce an active application identifier
the keywords “DATE” and “GPS” to introduce respectively a date or a place of use of the electronic device;
the keyword “ZONE_TYPE” to introduce a type of input zone in which the string of characters was detected. For example, the keyword WEB_URL_SEARCH can be used to specify that the string of characters was detected in a URL input zone;
the keyword “IN” to introduce a graphical object including the string of characters; and
the keyword “PROX” to introduce a graphical object or a text located in the vicinity of the string of characters.

For example, by reconsidering the examples described in relation to FIGS. 3 and 4, the client CLT_KNOW may use the following formats in the messages in the knowledge server SRV_KNOW:
MSG¹={TXT=“Dear”, ID_APP=ID_MSG, DATE=20220715, GPS=48.856614, 2.3522219}, when the obtaining module MOD_OBT detects the end of the word “Dear”,
MSG²={TXT=“Dear Sir”, ID_APP=ID_MSG, DATE=20220715, GPS=48.856614, 2.3522219}, when the obtaining module MOD_OBT detects the end of the word “Sir”,
MSG³={TXT=“fish”, ID_APP=ID_TTXT, IN=rectangle}, when the obtaining module MOD_OBT detects the end of the word “fish”,
MSG⁴={TXT=“translate trout into English”}, ID_APP=ID_TTXT}, when the obtaining module MOD_OBT detects the end of the word “English”,
MSG⁵={ZONE_TYPE: WEB_URL_SEARCH=“buy stock X pour 20 Euros”, ID_APP=ID_SRCHENG, IN=oblong, PROX=magnifying glass”, when the obtaining module MOD_OBT detects the end of the word “Euros”.

The messages sent after detection of the end of the words “translate”, “trout”, “into”, “buy”, “stock”, “X”, “to”, “20” are not detailed but are in the same format.

In one or more embodiment(s), the knowledge server SRV_KNOW includes a semantic analysis module for analyzing the messages received from the client CLT_KNOW, based on these keywords (into English “tag”) and interpretation rules.

Upon receipt of such a message, and after semantic analysis, the knowledge server SRV_KNOW is configured to determine whether or not the string of characters comprised in a message constitutes or not a command and if so to execute the command.

As previously specified, in some embodiments, the determination of whether or not the string of characters constitutes or not a command may depend on this string of characters and on the context of the active application.

Similarly, as previously specified, when it is determined that the string of characters constitutes a command, the actions implemented to execute this command may depend, in some embodiments, on this string of characters and on the context of the active application. In one or more embodiment(s), the semantic analysis module of the server SRV_KNOW therefore analyzes the message received to determine its meaning based on the string of characters (keyword TXT) and/or on the context of the active application and produce a semantic result in the form of rules interpretable by one or more third-party agent(s). In the example represented in FIGS. 2A and 2B, only 3 agents are represented, but in practice the number of agents can be much greater (for example several dozen).

As explained above, an agent can be dedicated to one or more application(s).

The agents can vary according to the embodiments, both in number and in functionality. For example, the agents can be declared or installed prior to the execution of the method (for example via a list of agents accessible via a human-machine interface).

For example, upon receipt of the message MSG⁴={TXT=“translate trout into English”}, ID_APP=ID_TTXT}, the semantic analysis module produces a message TRANSLATE (“trout”, “EN”) interpretable by a translation agent TRANS_AG.

The agent TRANS_AG interprets this message and returns the result RES⁴ describing the actions to be executed to process the command:

RES⁴ = {“success”: true, “code”: 200,
“stocks”: [{
“type”: “INSERT”,
“cmd”: {“value”: “trout”,“props”: [{“mimetype”:“text/plain”}]},
“txt”: “translate trout into English”
}]

For example, upon receipt MSG⁵={ZONE_TYPE: WEB_URL_SEARCH=“buy stock X for 20 Euros”, ID_APP=ID_SRCHENG, IN=oblong, PROX=magnifying glass”, the semantic analysis module produces a message STOCKS (“BUY”, “X”, “20”) interpretable by an agent STOCK_AG.

The agent STOCK_AG interprets this message and returns the result RES⁵ describing the actions to be executed to process the command:

RES⁵ = {“success”: true,“code”: 200,
“input_cmd”: “buy stock X for 20 Euros”,
“stocks”: [{
“type”: “INSERT”,
“cmd”: {“value”: “http://www.bourse.com#BUY=X#VAL=20€”,“props”:
[{“mimetype”:“text/plain”}]},
“txt”: “buy stock X for 20 Euros”
}]

In another example, if the semantic analysis module analyzes the string of characters “insert last image received by email”, the semantic analysis module can produce an interpretable message to a messaging agent MSG_AG configured to retrieve the list of emails sent, the contents of the emails and attachments, etc.).

In one or more embodiment(s), the knowledge server SRV_KNOW can optionally return to the client CLT_KNOW the result provided by the agent(s) (which will then be, for example; as already explained, used to replace the string of characters generated by the user).

In at least some embodiments, the result of the execution can for example consist of a text, an image, multimedia content or a URL.

In at least some embodiments, the knowledge server SRV_KNOW also sends back to the client CLT_KNOW a type of this content (text, image, video, URL, etc.).

In at least some embodiments, when the knowledge server determines that the string of characters is not a command, it sends back a response indicating that the received string of characters is not identified as a command (for example by using a keyword indicating this absence of identification, such as “NONE”).

For example, by reconsidering the example of the messages MSG¹ to MSG⁴, the knowledge server SRV_KNWL can determine that the string of characters of the messages MSG¹, MSG², MSG³ are not commands.

In at least some embodiments, the electronic device 101 can include an action management module MOD_GA for converting the response of the client CLT_KNOW into a list of actions (similar to user actions via an input peripheral) on the window of the active application concerned.

Thus, in at least some embodiments, the action management module MOD_GA can be configured to:
i/ delete a string of characters; and
ii/ optionally insert an object in place of this string of characters, for example at the position POS identified by the module MOD_OCR.

In at least some embodiments, to delete a string of characters, the action management module MOD_GA simulates, for the active application, presses on the key “DELETE” on the keyboard intended to delete the last character(s) entered.

In at least some embodiments, to insert an object in place of a string of characters, the action management module MOD_GA copies this object into the clipboard and pastes the content of the clipboard at the position POS.

Thus, in the examples above:
upon receipt of the response RES⁴, the action management module MOD_GA replaces the string of characters “translate trout into English” with the string of characters “trout” in the text zone ZT;
upon receipt of the response RSP⁵, the action management module MOD_GA replaces the string of characters “buy stock X for 20 Euros” with the URL http://www.bourse.com #BUY=X#VAL=20€ in the oblong shape, in the vicinity of the magnifying glass.

Moreover, some commands from a user may not require inserting new content into the active window. This is the case, for example, when the command is a control command for a home automation appliance, for example “turn on light”. In such embodiments, the text corresponding to the command may be simply deleted, the command to be performed being furthermore transmitted to the system or to the application concerned (for example to the home automation system).

According to the embodiments, the method may operate systematically or be activated following an implementation command (via, for example, a manual action by a user of the electronic device 101).

Similarly, in some embodiments, the method may be deactivated, for example, via a manual action by a user. In this embodiment, the device S may include a module MOD_ACT for activating and deactivating the method.

FIG. 5 illustrates steps of the execution method in at least some embodiments. In this example, the method is implemented by an application executed in the background by the electronic device 101.

It will be assumed that during a first step ACT, the method has been activated by the user, and that the method comprises a subscription, during a step ABON, to the operating system OS to be notified of changes in the active application and user inputs.

In the example illustrated, during a step OBT, the method can obtain at least a first data coming from an input device/peripheral. This data results, for example, from an interpretation, at the level of an input peripheral, of an action performed by a user of the electronic device 101. This action is, for example, a succession of key presses detected at the level of the keyboard (103b) of the electronic device 101. In this example, the data can correspond to at least one character(s) and/or strings of characters, representing the interpretation of the key presses performed by the user.

In the illustrated example, the at least one data may comprise, for example, a fixed number n (n integer greater than 1) of characters coming from the input peripheral, the character(s) obtained corresponding to the last n character(s) typed/entered by the user at the level of the keyboard. Concretely, the character(s) just typed/entered by the user are added/stored in one or more buffer zone(s) (of fixed maximum size for example) such as a FIFO (First In First Out) type list. The characters added fill the list until it is full. Once the list is full, each character added will replace the oldest character contained in the list. Such an embodiment makes it possible to have in memory at any time the last character(s) (for example the last word(s)) entered by the user at the level of the input peripheral of the electronic device 101 regardless of the input zone for these characters.

As mentioned above, either a single buffer zone is supplied by all the characters entered, independently of the active application, or a buffer zone is used per active application or per input zone of each active application.

In the example of FIG. 5, during a step IMG, the method comprises obtaining an image representative of the content displayed by a display peripheral 105 of the electronic device 101. The image is for example obtained from software executed by the electronic device 101 able to capture the graphical content of the display peripheral 105 of the electronic device 101 (for example a software probe).

According to another example, the image can be obtained from a third-party device (for example a camera or a Smartphone) positioned so as to capture the content displayed by a display peripheral 105 of the device 101. The latter case can involve the transmission of the image by the third-party device to the device 101.

In the example of FIG. 5, an optical character recognition (step OCR) can for example be applied to the image obtained. The optical character recognition makes it possible to obtain an at least partial transcription of the text contained in the image obtained/generated in the form of a string/sequence of characters, it also makes it possible to associate with at least one transcribed character (for example with each transcribed character) its position within the image obtained.

According to at least one embodiment, the optical character recognition can be performed by third-party software and the result, i.e. the transcription of the text (string/sequence of characters and, optionally; their associated position), is emitted by the third-party software to the application implementing the method that is the object of the present application.

Once the transcription has been obtained, the method can comprise a search (step RECH) (and if the search is positive, a detection) of the character(s) stored in at least one buffer zone (step OBT) within the transcribed character sequence. When the search is positive, the method determines (step DET) whether or not the detected string of characters constitutes a user command. This determination is made from the string of characters and from the textual context of the active application at the time of generating this string of characters. The context can comprise:
the identifier of the active application;
information relating to graphical objects detected by the module in the vicinity of the string of characters;
a date and/or a place of use of the electronic device at the time of obtaining the string of characters.

Taking into account the place of use of the electronic device for example makes it possible to determine the target (in terms of target device or application, for example) of a home automation command. For example, the command “turn on the light” can be interpreted to turn on the light at home or in the office depending on the place of use of the device and therefore be addressed, depending on the place of use of the electronic device, to different home automation applications or devices.

Taking into account the date of use of the electronic device for example makes it possible to determine the action to be implemented to process a home automation command. For example, the command “put on standby” can be interpreted to put the device on standby with different standby levels (in terms of energy saving and recovery time in particular) depending on the time of use of the device (or even turn off the device).

The method can also be used, in some embodiments, to interpret management commands for a business tool. For example, for employees who are used to entering the time spent on some tasks in a time tracking tool, the method can allow them to enter a command of the type “value 3H” in the environment of an active application, this command being interpreted to feed this time tracking tool with the duration and the identifier of the active application.

In some embodiments, when the method detects that the string of characters corresponds to a command:
it deletes this string of characters (step SUPPR);
it executes the command (step EXEC); and
possibly it inserts a content representative of the result of the execution of the command at the position POS of the deleted text (step INSER).

In the examples described above, the client CLT_KNOW and the knowledge server SRV_KNOW can be located on different entities or incorporated either or both of them in the electronic device 101.

The client-server architecture of the detailed embodiments is optional, the functions of the client and of the server can be implemented differently, for example within the same software function, in some embodiments.

1. A method for executing a command generated via at least one input peripheral of an electronic device within a framework of an active application on the electronic device, the method being implemented by another application adapted to run in the background on the electronic device and comprising:
obtaining a string of at least one character displayed on a display peripheral of said electronic device in a graphical environment of the active application and generated by at least one data coming from said at least one input peripheral;
determining whether said string of characters constitutes a command from a user of said electronic device, said determination being a function of said string of characters and furthermore a function:
of the active application, and/or
of a date of obtaining the string of characters; and/or
of a place of obtaining the string of characters;
and in response to the determination being positive:
executing said command.

2. The method according to claim 1, further comprising a continuous storage of the characters entered by a user in a buffer zone of a memory reserved for the active application.

3. The method according to claim 1, characterized in that wherein said determination takes into account a type of an input zone for said string of characters.

4. The method according to claim 1, further including:
a determination of a position of the display of said string of characters on said display peripheral; and
a display, on said display peripheral and in a vicinity of said position, of a result of the execution of said command.

5. The method according to claim 4, wherein said position is determined thanks to an optical character recognition within an image representative of a content displayed by said display peripheral.

6. The method according to claim 1, further including a detection of said string of characters in at least a second string of characters obtained by an optical character recognition applied to all or part of an image representative of a content displayed by said display peripheral.

7. The method according to claim 6, wherein said optical character recognition is applied to part of said image corresponding to the graphical environment of said active application, displayed by said display device.

8. The method according to claim 1, further including a pre-activation via an input interface of said device.

9. The method according to claim 1, said method being executed:
upon detection of at least a first character; and/or
upon detection of an end of a word; and/or
upon detection of a pause in a generation of said characters.

10. The method according to claim 1, wherein said method is executed at regular intervals.

11. The method according to claim 1, wherein said determination includes a semantic analysis of said string of characters and said execution includes a processing of a result of said semantic analysis by at least one agent.

12. A device for executing a command generated via at least one input peripheral of an electronic device within a framework of an active application on the device, wherein the device comprises:
at least one processor; and
at least one non-transitory computer readable medium comprising instructions stored thereon which when executed by the at least one processor configure the device to:
obtain a string of at least one character displayed on a display peripheral of said electronic device in a graphical environment of the active application and generated by at least one data coming from said at least one input peripheral;
determine whether said string of characters constitutes a command from a user of said electronic device, said determination being a function of said string of characters and furthermore a function:
of the active application; and/or
of a date of obtaining said string of characters; and/or
of a place of obtaining said string of characters;
in response to the determination being positive:
executing said command.

13. The device for executing a command according to claim 13 wherein the instructions further configure the device to delete said string of characters on said display peripheral of said electronic device.

14. The method according to claim 1 further comprising, in response to the determination being positive, deleting said string of characters on said display peripheral.

15. At least one non-transitory computer readable medium comprising instructions stored thereon which when executed by at least one processor of an electronic device configure the device to implement a method of executing a command generated via at least one input peripheral of the electronic device within a framework of an active application on the electronic device, the method being implemented by another application adapted to run in the background on the electronic device and comprising:
obtaining a string of at least one character displayed on a display peripheral of said electronic device in a graphical environment of the active application and generated by at least one data coming from said at least one input peripheral;
determining whether said string of characters constitutes a command from a user of said electronic device, said determination being a function of said string of characters and furthermore a function:
of the active application, and/or
of a date of obtaining the string of characters; and/or
of a place of obtaining the string of characters;
and in response to the determination being positive:
executing said command.
